(19) United States
(12) Patent Application Publication
(10) Pub. No.: US 2017/0057075 A1
(43) Pub. Date: Mar. 2, 2017

(54) ELECTRIC TOOL

(71) Applicant: HITACHI KOKI CO., LTD., Tokyo (JP)

(72) Inventor: Yuuki TAKEDA, Ibaraki (JP)

(21) Appl. No.: 15/119,960

(22) PCT Filed: Jan. 23, 2015
(86) PCT No.: PCT/JP2015/051864

§ 371 Date: Aug. 18, 2016

(30) Foreign Application Priority Data
Feb. 28, 2014 (JP) 2014-039636

(51) Int. Cl. B25F 5/02; B24B 55/05; B24B 23/02

(52) U.S. Cl. CPC B25F 5/02; B24B 23/028; B24B 55/052

(57) ABSTRACT

A grinder includes a spindle on which a grindstone wheel is mounted, and a wheel guard covering the grindstone wheel, the grinder including: an attachment portion having a housing portion and provided to a main body rotatably holding the spindle to surround the spindle; a fitting portion being provided to the wheel guard and fitting into the attachment portion; locking pieces disposed to the fitting portion at a different position in a circumferential direction of the spindle; cut-out portions disposed to the attachment portion at a different position in the circumferential direction and allowing the locking pieces to enter the housing portion; and an inner circumferential edge disposed to the attachment portion at a different position from the positions of the cut-out portions in the circumferential direction and being pressed against the locking pieces housed in the housing portion.

### TECHNICAL FIELD

The present invention relates to an electric tool mounted with a rotating tool.

### BACKGROUND ART

A grinder, which is an example of an electric tool, is provided with a rotationally driven spindle. Various rotating tools can be attached to the spindle according to a purpose and a use. The rotating tool may be a disk-shaped grindstone, a brush, a cutter, and the like. In the following description, the various rotating tools attached to the spindle may be collectively referred to as a “wheel,” in some cases. To prevent machining powder caused when the wheel comes in contact with an object from scattering toward an operator, the above-described grinder is mounted with a wheel guard covering a part of the wheel in a circumferential direction.

The grinder mounted with the wheel guard is described in Patent Document 1. The grinder according to Patent Document 1 includes a grinder main body and a housing (packing gland) attached to the grinder main body. A cylindrical attachment portion is provided to a tip of the packing gland. The spindle is disposed inside the packing gland and the attachment portion, and a tip of the spindle is disposed to the outside of the attachment portion. Of the spindle, a grindstone as the wheel is mounted in a part disposed to the outside of the attachment portion.

In addition, there is provided the wheel guard covering an outer periphery of the grindstone, and the wheel guard is provided with a locking portion. The locking portion has an arc shape, and a nut is fixed to each of both ends in a circumferential direction of the locking portion.

Also, there is provided a set plate that fixes the wheel guard to the attachment portion. The set plate has an arc shape. The wheel guard is fixed to the attachment portion by bringing an inner peripheral surface of the locking portion of the wheel guard into contact with an outer peripheral surface of the attachment portion and bringing an inner peripheral surface of the set plate into contact with the outer peripheral surface of the attachment portion, and by fastening a fixing screw and sandwiching the attachment portion with the set plate and the locking portion.

### RELATED ART DOCUMENT

### Patent Document

Patent Document 1: Japanese Examined Utility Model Application Publication No. S59-3797

### SUMMARY OF THE INVENTION

### Problems to be Solved by the Invention

The grinder according to Patent Document 1, however, has required an operation of fastening the fixing screw again after the fixing screw is once loosened and the rotational position of the wheel guard is determined, upon changing a rotational position of the wheel guard.

Also, the grinder according to Patent Document 1 is configured to perform positioning of the wheel guard in an axial direction by providing a taper on the outer peripheral surface of the attachment portion and the inner peripheral surface of the set plate; however, processing of the taper has not been easy.

An object of the present invention is to provide an electric tool to which a wheel guard can be easily attached and of which positioning in an axial direction can be performed by using a simple configuration.

### Means for Solving the Problems

A grinder according to the present invention is an electric tool provided with a spindle on which a rotating tool is mounted, and a wheel guard covering the rotating tool mounted on the spindle, the electric tool including: an attachment portion including a housing portion and provided to a main body rotatably holding the spindle so as to surround the spindle; a fitting portion provided to the wheel guard and being fitted into the attachment portion; a plurality of locking pieces disposed to the fitting portion at a different position in a circumferential direction of the spindle; a plurality of cut-out portions disposed to the attachment portion at a different position in the circumferential direction and allowing at least one of the plurality of locking pieces to enter the housing portion; and a support portion disposed to the attachment portion at a different position from the position of the plurality of cut-out portions in the circumferential direction and being pressed against the plurality of locking pieces housed in the housing portion.

### Effects of the Invention

According to the present invention, the wheel guard can be easily attached, and the positioning in the axial direction can be performed with a simple configuration.

### BRIEF DESCRIPTIONS OF THE DRAWINGS

FIG. 1 is a cross-sectional front view illustrating a structure of a grinder according to a first embodiment of the present invention;

FIG. 2(a) is a bottom view of a packing gland of the grinder according to the first embodiment of the present invention;

FIG. 2(b) is a side view of the packing gland of the grinder according to the first embodiment of the present invention;

FIG. 2(c) is a cross-sectional bottom view of the packing gland of the grinder taken along an A-A line of FIG. 2(b) according to the first embodiment of the present invention;

FIG. 3(a) is a bottom view of a wheel guard of the grinder according to the first embodiment of the present invention;

FIG. 3(b) is a side view of the wheel guard of the grinder according to the first embodiment of the present invention;

FIG. 3(c) is a cross-sectional bottom view of the wheel guard of the grinder taken along a B-B line of FIG. 3(b) according to the first embodiment of the present invention;

FIG. 4(a) is a side view illustrating an essential part of the grinder according to the first embodiment of the present invention and a procedure for attaching the wheel guard to the packing gland;

FIG. 4(b) is a cross-sectional bottom view illustrating an essential part of the grinder according to the first embodiment of the present invention and a fitting state between an attachment base and a fitting portion;

FIGS. 5(a) to 5(d) are explanatory views illustrating essential parts of the grinders according to the first embodiment of the present invention and a procedure for changing an attachment position of the wheel guard by rotating the wheel guard relative to the packing gland;

FIG. 6 is a partial cross-sectional front view illustrating a structure of a grinder according to a second embodiment of the present invention;

FIG. 7 is an exploded perspective view of components used in the grinder according to the second embodiment of the present invention;

FIG. 8 is a cross-sectional front view illustrating a structure of a packing gland and a wheel guard of FIG. 6;

FIG. 9 is a cross-sectional front view illustrating a state in which the wheel guard of FIG. 6 is not attached to the packing gland;

FIGS. 10(A) and 10(B) are cross-sectional bottom views illustrating essential parts of the grinders according to the second embodiment of the present invention and a positional relation between the wheel guard and a fitting portion in a circumferential direction of the fitting portion;

FIG. 11 is an exploded perspective view illustrating a first modification of the wheel guard and a cover used in the grinder of FIG. 6;

FIG. 12 is a cross-sectional front view illustrating a state before the wheel guard of FIG. 11 is attached to the packing gland;

FIG. 13 is a cross-sectional front view illustrating a state in which the wheel guard of FIG. 11 is attached to the packing gland;

FIG. 14 is an exploded perspective view illustrating a second modification of the wheel guard and a cover used in the grinder of FIG. 6;

FIGS. 15(A) and 15(B) are cross-sectional bottom views illustrating the wheel guard and the packing gland of FIG. 14; and

FIGS. 16(A) and 16(B) are cross-sectional bottom views illustrating the wheel guard and the packing gland of FIG. 14.

### DETAILED DESCRIPTION OF PREFERRED EMBODIMENTS

Hereinafter, a grinder which is an embodiment of an electric tool of the present invention will be described in detail with reference to the drawings.

### First Embodiment

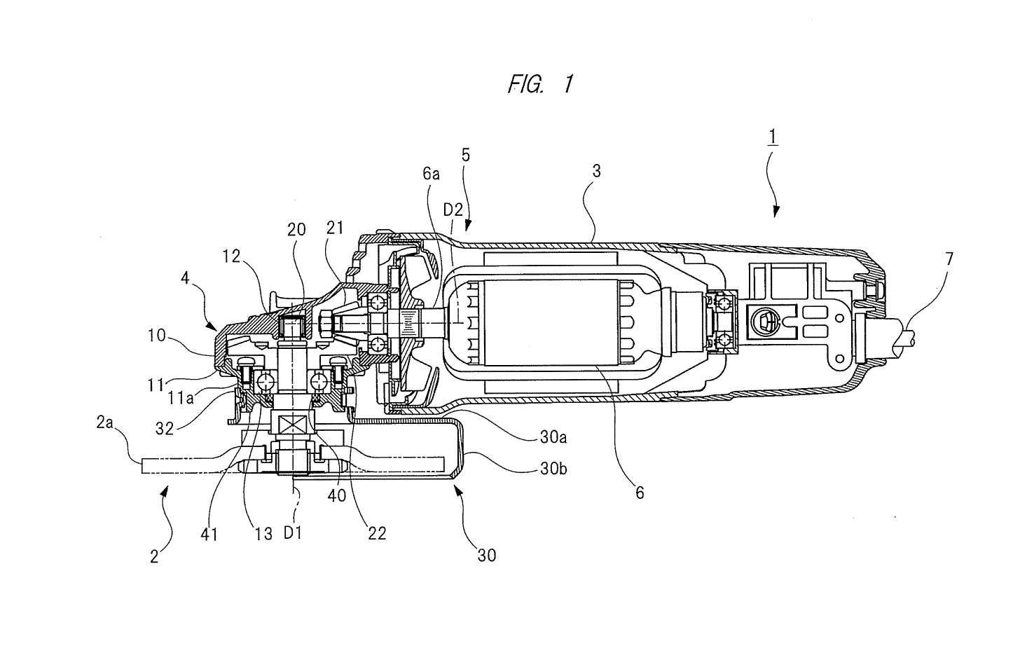

As illustrated in FIG. 1, a grinder 1 according to a first embodiment is provided with a diamond grindstone wheel as a rotating tool. The diamond grindstone wheel is hereinafter referred to as a “grindstone wheel 2.” The grinder 1 is used in grinding work for flattening a surface of concrete, a stone material, and the like.

The grinder 1 is provided with a main body 5 constituted by a housing 3 and a gear case 4. The housing 3 has a substantially cylindrical shape as a whole, and an electric motor 6 as a driving source is housed inside the housing 3. The electric motor 6 is connected to a commercial power supply through a power supply code 7 drawn out from a rear end of the housing 3. A bevel gear 21 is fixed to an output shaft 6a of the electric motor 6.

The gear case 4 includes a case main body 10 and a packing gland 11 as a lid member for sealing an opening of the case main body 10 and is attached to a tip of the housing 3. Inside the gear case 4, a needle bearing 12 and a ball bearing 13 are provided as two bearings. A spindle 20 which is an output shaft of the grinder 1 is rotatably held by the needle bearing 12 and the ball bearing 13. In FIG. 1 which is a sectional front view of the grinder 1, a center line D1 of the spindle 20 is disposed to be orthogonal to a center line D2 of the output shaft 6a of the electric motor 6, and one end of the spindle 20 penetrates through the packing gland 11 and protrudes to the outside.

In contrast, a bevel gear 22 is attached to the other end of the spindle 20 positioned inside the gear case 4, and the bevel gear 22 is meshed with the bevel gear 21. Rotational force of the electric motor 6 is transmitted to the spindle 20 through the pair of the bevel gears 21 and 22, and a rotation speed of the spindle 20 is decelerated relative to a rotation speed of the output shaft 6a. That is, the spindle 20 is rotationally driven by the electric motor 6. In FIG. 1, the center line D2 of the output shaft 6a crosses the center line D1 of the spindle 20 at an angle of 90 degrees.

The grindstone wheel 2 is provided with a substrate 2a made of a disk-shaped steel sheet, and on a surface of the substrate 2a, a plurality of diamond grindstones are fixed by adhesion or any other means. At the center of the substrate 2a, there is provided an attachment hole through which the spindle 20 is inserted, and the grindstone wheel 2 is mounted in the spindle 20 which penetrates through the attachment hole. Specifically, the grindstone wheel 2 is fixed to the spindle 20 by a wheel washer and a lock nut, whereby the grindstone wheel 2 rotates integrally with the spindle 20.

A non-illustrated switch is provided to the housing 3, and by operating the switch, electric power is supplied to the electric motor 6, so that the output shaft 6a of the electric motor 6 is rotated. Then, the spindle 20 coupled to the output shaft 6a through the pair of the bevel gears 21 and 22 is rotated, and the grindstone wheel 2 fixed to the spindle 20 is rotated.

A wheel guard 30 covering at least a half or more of an outer periphery of the grindstone wheel 2 is attached to the gear case 4. The wheel guard 30 is integrally molded of a material such as synthetic resin and metal. Hereinafter, an attachment structure of the wheel guard 30 will be described in detail.

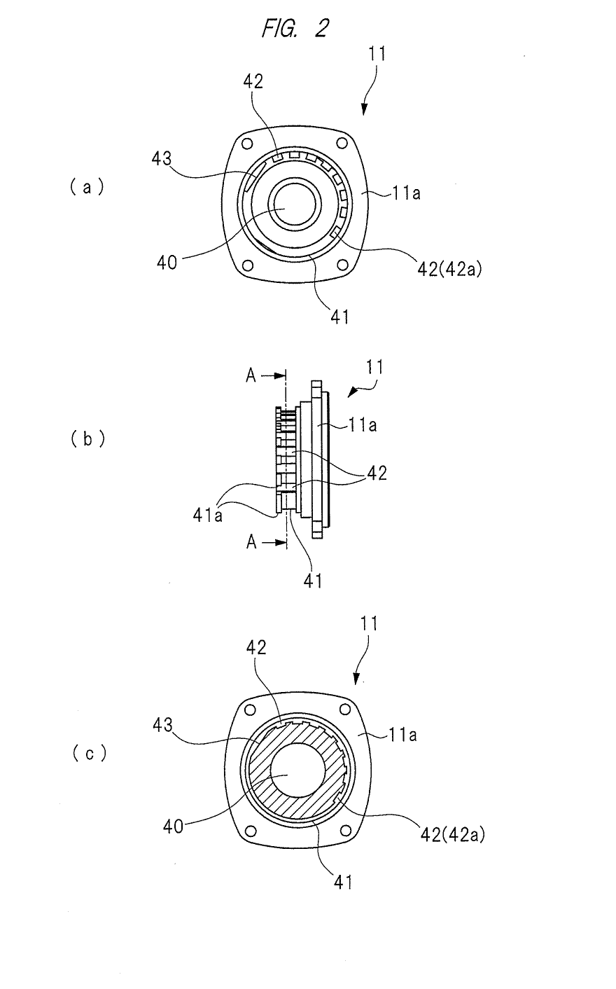

As illustrated in FIGS. 2(a) and 2(c), at the center of the packing gland 11, there is provided a through hole 40 through which the spindle 20 illustrated in FIG. 1 penetrates. As illustrated in FIGS. 2(a) to 2(c), the packing gland 11 includes a boss portion 11a fixed to the case main body 10 by a screw member, and a cylindrical attachment base 41 protruding in a direction along the center line D1 from the boss portion 11a. The boss portion 11a and the attachment base 41 are integrally molded. The attachment base 41 is formed around the through hole 40 so as to surround the through hole 40. Also, the attachment base 41 extends downward along an axial line of the through hole 40. In other words, the attachment base 41 is formed in a ring shape, and an axial line of the attachment base 41 and the axial line of the through hole 40 coincide with the center line D1. That is, as in FIG. 1, the attachment base 41 surrounds the spindle 20 protruding from the through hole 40.

On an outer peripheral surface of the attachment base 41, a plurality of recessed portions 42 are provided at a regular interval along a circumferential direction thereof. Specifically, as illustrated in FIGS. 2(a) and 2(c), eight recessed portions 42 are formed on approximately a half of the outer peripheral surface of the attachment base 41. In contrast, in a region where the recessed portions 42 are not formed on the outer peripheral surface of the attachment base 41, a relief portion 43 is formed. The relief portion 43 is recessed toward the inside of the attachment base 41, and a bottom surface of the relief portion 43 is flat. Note that, as illustrated in FIGS. 2(a) and 2(c), among the eight recessed portions 42, there is a recessed portion 42a that opposes the relief portion 43 interposing a center of the through hole 40. That is, the relief portion 43 and the recessed portion 42a are disposed at positions different by 180 degrees and are opposing to each other.

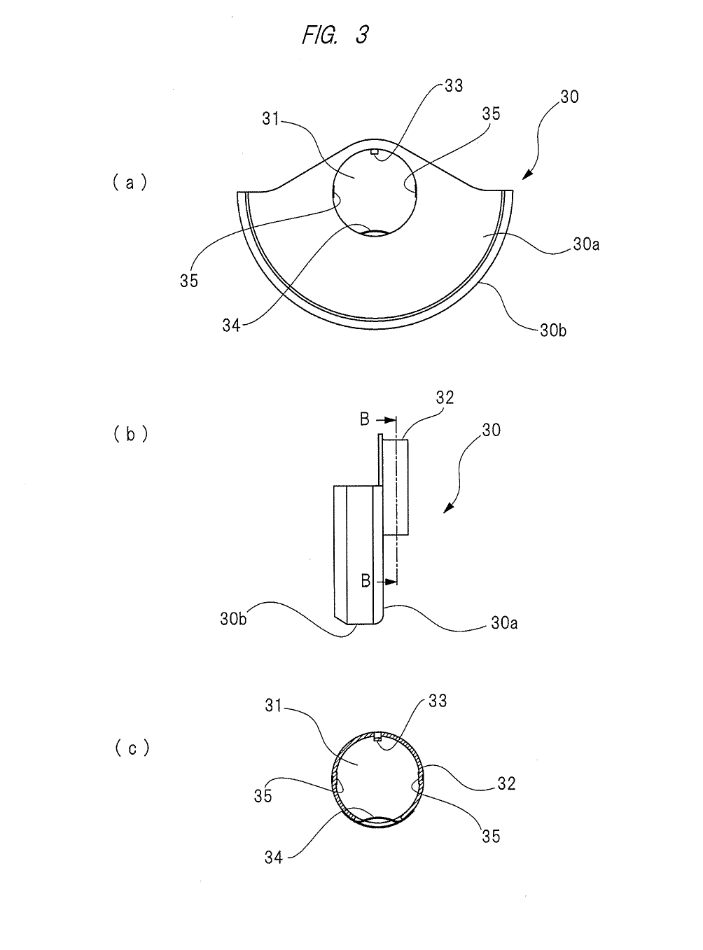

Furthermore, as illustrated in FIG. 2(b), engagement portions 41a are provided in a region where the recessed portions 42 are not provided at an end on a grindstone wheel 2 side in a direction along the axial line of the attachment base 41. The engagement portion 41a protrudes to the outside from the outer peripheral surface of the attachment base 41, and the engagement portion 41a engages with a protrusion portion 35 of a fitting portion 32 illustrated in FIG. 3 described below. That is, the engagement portion 41a is provided on the attachment base 41 in a region other than the region where the recessed portions 42 are provided.

As illustrated in FIG. 1, the wheel guard 30 has a cover unit constituted by a horizontal portion 30a spreading in a radial direction of the spindle 20 and a vertical portion 30b extending in an axial direction of the spindle 20 from an edge of the horizontal portion 30a. The wheel guard 30 has a substantially sector shape in a plan view of FIG. 3(a). In other words, the horizontal portion 30a of the wheel guard 30 is parallel to a rotation plane of the grindstone wheel 2. In contrast, the vertical portion 30b of the wheel guard 30 is at a right angle to the rotation plane of the grindstone wheel 2 and covers an outer side in the radial direction of the grindstone wheel 2.

As illustrated in FIG. 3(a), a substantially circular opening 31 is formed in the horizontal portion 30a of the wheel guard 30. As illustrated in FIG. 3(b), the cylindrical fitting portion 32 which extends upward along an axial line of the opening 31 from an edge of the opening 31 is integrally molded with an upper surface of the horizontal portion 30a. Note that it is also possible to integrate the horizontal portion 30a and the fitting portion 32 that are separate bodies by welding and the like.

As illustrated in FIGS. 3(a) and 3(c), a projection portion 33 is provided to an inner peripheral surface of the fitting portion 32. Also, to a position on the inner peripheral surface of the fitting portion 32 and opposed to the projection portion 33, a plate spring 34 as an elastic body is provided. That is, the projection portion 33 and the plate spring 34 are disposed at positions different by 180 degrees and are opposing to each other. In other words, the projection portion 33 and the plate spring 34 are disposed at symmetrical positions relative to the spindle 20 illustrated in FIG. 1. The plate spring 34 is curved toward the inside of the fitting portion 32. Specifically, each of both ends of the plate spring 34 is fixed to the inner peripheral surface of the fitting portion 32 while the center of the plate spring 34 protrudes toward the center of the fitting portion 32. In other words, the plate spring 34 is curved such that the center thereof in a longer direction comes the closest to the projection portion 33.

Furthermore, on the inner peripheral surface of the fitting portion 32, there is provided a pair of protrusion portions 35 protruding toward the inside from the inner peripheral surface thereof. An amount of protrusion of the protrusion portions 35 toward the inside in a radial direction of the fitting portion 32 is smaller than an amount of protrusion of the projection portion 33. Engagement between this protrusion portion 35 and the engagement portion 41a of the attachment base 41 illustrated in FIG. 2(b) in a vertical direction prevents the wheel guard 30 from falling off from the attachment base 41. Also, the plate spring 34 and the projection portion 33 engage with the engagement portion 41a in the vertical direction, whereby the falling of the wheel guard 30 from the attachment base 41 can be prevented more securely. The above-described “vertical direction” means the direction along the center line D1.

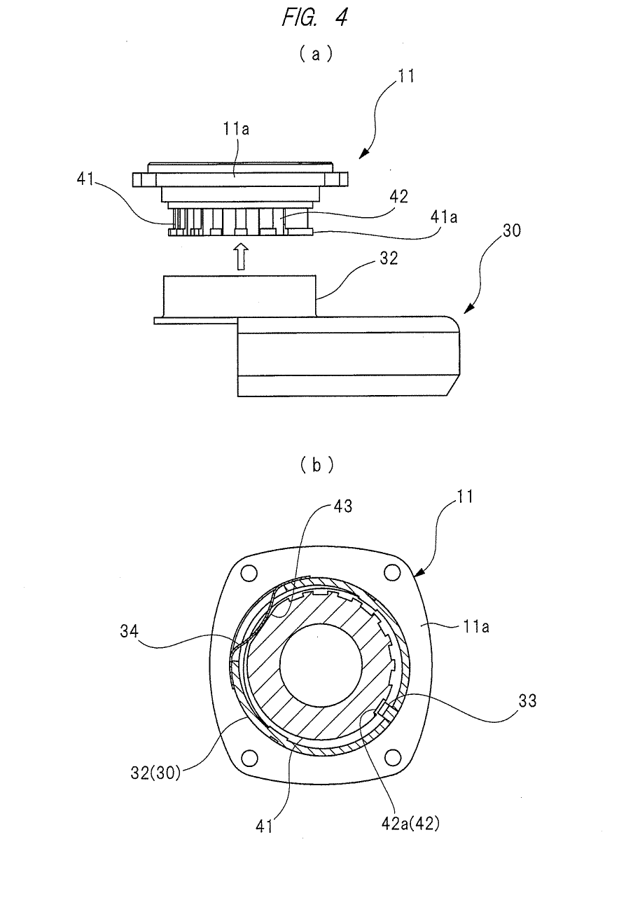

As illustrated in FIG. 4(a), the wheel guard 30 is attached to the packing gland 11 from below the packing gland 11. In other words, the attachment base 41 extending downward from a lower surface of the packing gland 11 is fitted into the inside of the fitting portion 32 extending upward from an upper surface of the wheel guard 30.

As illustrated in FIG. 4(b), when the attachment base 41 is fitted into the fitting portion 32, a position of the relief portion 43 provided to the attachment base 41 is aligned with a position of the plate spring 34 provided to the fitting portion 32. When the relief portion 43 and the plate spring 34 are aligned with each other, a position of the recessed portion 42a opposed to the relief portion 43 is automatically aligned with a position of the projection portion 33 opposed to the plate spring 34. Note that, when the recessed portion 42a is aligned with the projection portion 33, it is obvious that the position of the relief portion 43 is automatically aligned with the position of the plate spring 34. In either case, when the attachment base 41 is fitted into the fitting portion 32, as illustrated in FIG. 4(b), the plate spring 34 provided on the inner peripheral surface of the fitting portion 32 is disposed between the inner peripheral surface of the fitting portion 32 and the outer peripheral surface of the attachment base 41. More specifically, the plate spring 34 is disposed between the inner peripheral surface of the fitting portion 32 and a bottom surface of the relief portion 43.

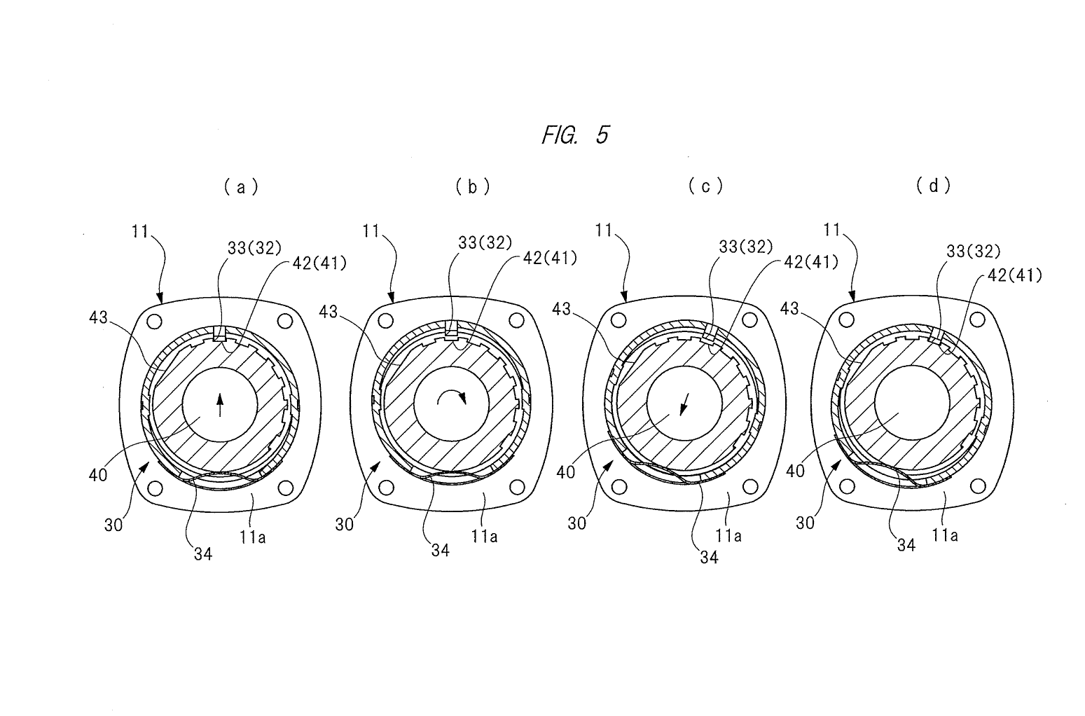

Subsequently, by rotating the wheel guard 30 provided with the fitting portion 32 illustrated in FIG. 4(b) in a counterclockwise direction, as illustrated in FIG. 5(a), from a gap between the inner peripheral surface of the fitting portion 32 and the bottom surface of the relief portion 43, the plate spring 34 is pressed into a gap between the inner peripheral surface of the fitting portion 32 and the outer peripheral surface of the attachment base 41 and is bent. Then, due to elastic restoration force of the plate spring 34 that has been bent, the wheel guard 30 is displaced, or moved, from a fitting portion 32 side to a vertical portion 30b side illustrated in FIG. 3(b). As a result, as illustrated in FIG. 5(a), the projection portion 33 at the position different by 180 degrees in a circumferential direction of the fitting portion 32 relative to the wheel guard plate spring 34 is drawn toward the opposing recessed portion 42 and is fitted into the recessed portion 42. That is, by an energization of the plate spring 34, the recessed portion 42 of the attachment base 41 is fitted into the projection portion 33 of the fitting portion 32, whereby the wheel guard 30 is fixed.

The following procedure is taken to change a position of the wheel guard 30 illustrated in FIG. 5(a) in a circumferential direction of the wheel guard 30 relative to the packing gland 11. First, the wheel guard 30 is pressed or pulled to displace the wheel guard 30 in a radial direction (arrow direction) of the through hole 40 against the energization of the plate spring 34. In other words, by bending the plate spring 34, the wheel guard 30 is displaced, or moved, from the vertical portion 30b side to the fitting portion 32 side illustrated in FIG. 3(b).

Then, as illustrated in FIG. 5(b), the projection portion 33 is disengaged from the recessed portion 42. That is, fitting between the recessed portion 42 of the attachment base 41 and the projection portion 33 of the fitting portion 32 is released, whereby fixing of the wheel guard 30 is released. Note that it is clear from the descriptions above and the drawings that a radial direction of the through hole 40 illustrated in FIG. 5(a) is the same direction as the radial direction of the spindle 20 illustrated in FIG. 1. That is, by displacing the wheel guard 30 in the radial direction of the spindle 20 against the energization of the plate spring 34, the fitting between the recessed portion 42 and the projection portion 33 is released, whereby the fixing of the wheel guard 30 is released. That is, the wheel guard 30 becomes rotatable in a circumferential direction of the spindle 20.

Next, while retaining a state in which the wheel guard 30 is pressed or pulled, the wheel guard 30 is rotated in the circumferential direction, or in the arrow direction illustrated in FIG. 5(b), by a desired angle. For example, as illustrated in FIGS. 5(b) and 5(c), the wheel guard 30 is rotated by one recessed portion 42 only.

Subsequently, when pressing or pulling of the wheel guard 30 is released, as illustrated in FIG. 5(d), by the energization of the plate spring 34, the projection portion 33 is fitted into a new recessed portion 42, and the wheel guard 30 is fixed again. Note that to displace the wheel guard 30 as above, a clearance is necessary between the inner peripheral surface of the fitting portion 32 and the outer peripheral surface of the attachment base 41. Specifically, when the wheel guard 30 is displaced in the radial direction of the spindle 20, the projection portion 33 is also displaced, or moved, in the same direction by the same distance. Then, to disengage the projection portion 33, which is fitted into the recessed portion 42, from the recessed portion 42, it is necessary that a moving distance of the projection portion 33 exceeds a fitting length. Accordingly, the clearance necessary for securing the moving distance exceeding the fitting length is provided between the inner peripheral surface of the fitting portion 32 and the outer peripheral surface of the attachment base 41. In this embodiment, the above-described clearance is secured by making a cross-sectional shape of the fitting portion 32 substantially elliptical.

In this embodiment, by displacing the wheel guard 30 illustrated in FIG. 1 in the radial direction of the spindle 20, the fitting between the recessed portion 42 provided to the packing gland 11 illustrated in FIG. 2 and the projection portion 33 provided to the wheel guard 30 illustrated in FIG. 3 is released, whereby the fixing of the wheel guard 30 is released. In other words, even when upward force in the direction along the center line D1 of the spindle 20 or downward force in the direction along the center line D1 is applied to the wheel guard 30, the fitting between the recessed portion 42 and the projection portion 33 is not released, whereby the fixing of the wheel guard 30 is also not released. Thus, there is a very low possibility that the fixing of the wheel guard 30 is released against an intention of an operator using the grinder 1.

Furthermore, when the grindstone wheel 2 illustrated in FIG. 1 is damaged while rotating, in many cases, a fragment of the grindstone wheel 2 collides with an inner surface of the vertical portion 30b of the wheel guard 30. At this time, outward force in the radial direction of the spindle 20 is applied to the wheel guard 30. In other words, force acting to release the fixing of the wheel guard 30 is applied to the wheel guard 30.

However, as illustrated in FIGS. 3(a) and 3(c), the projection portion 33 is disposed on an opposite side of the vertical portion 30b interposing the center of the fitting portion 32. Thus, the projection portion 33 is not disengaged from the recessed portion 42 illustrated in FIG. 2 by the force applied to the wheel guard 30 when the fragment of the grindstone wheel 2 collides with the inner surface of the vertical portion 30b. In other words, the force applied to the wheel guard 30 when the fragment of the grindstone wheel 2 collides with the inner surface of the vertical portion 30b may act to strengthen the fitting between the recessed portion 42 and the projection portion 33 but not to release the fitting between the recessed portion 42 and the projection portion 33.

Furthermore, to release the fixing of the wheel guard 30, it is necessary to operate the wheel guard 30 only. Thus, the number of components may be reduced compared to a case where a release button for releasing the fixing of the wheel guard 30 is provided. Moreover, the fixing of the wheel guard 30 may be easily released even with work gloves on, so that excellent operability is achieved. Furthermore, there is a very low possibility that the fixing of the wheel guard 30 is released when working while pressing the main body 5 to the grindstone wheel 2 side.

The present invention is not to be limited to the first embodiment and may be modified in various ways within a scope not deviating from the gist thereof. For example, the plate spring 34 as the elastic body may be replaced with a coil spring, a rubber, and the like. The projection portion 33 may be provided to any one of the attachment base 41 and the fitting portion 32, and the recessed portion 42 may be provided to the other of the attachment base 41 and the fitting portion 32. That is, it is also possible to provide the projection portion 33 to the attachment base 41 and to provide the recessed portion 42 to the fitting portion 32. Moreover, the projection portion 33 may be provided to any one of the wheel guard 30 and the attachment base 41, and the recessed portion 42 may be provided to the other of the wheel guard 30 and the attachment base 41. Furthermore, the numbers of the recessed portions 42 and the projection portions 33 as well as disposition thereof may be appropriately changed as necessary.

### Second Embodiment

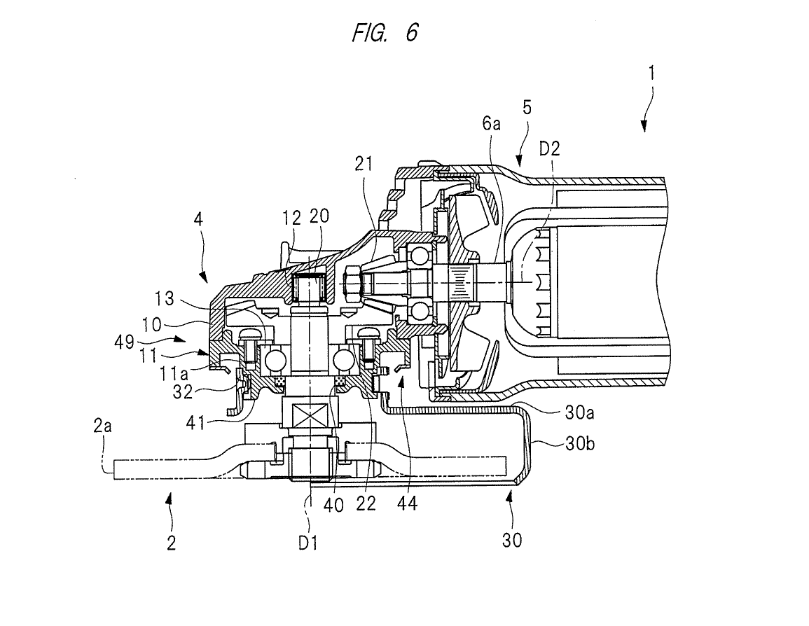

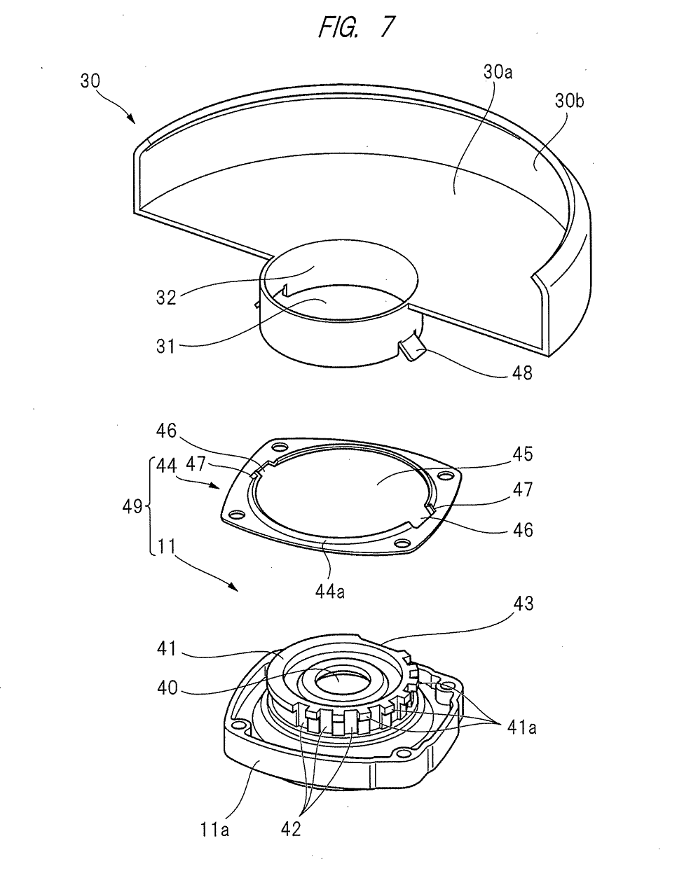

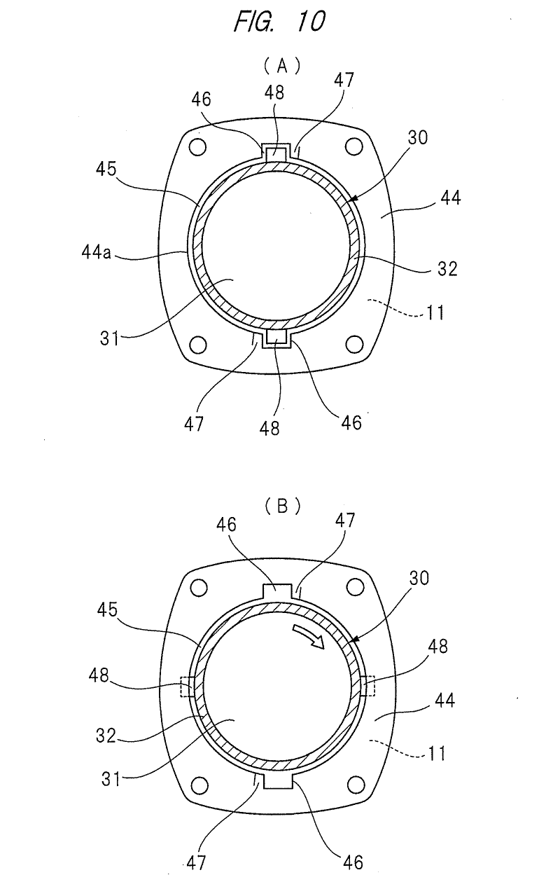

Next, a grinder according to a second embodiment of the present invention will be described with reference to FIGS. 6 to 10. In a grinder 1 according to the second embodiment, a component part that is the same as that of the grinder 1 according to the first embodiment is denoted by the same reference character as the grinder 1 according to the first embodiment. Note that the projection portion 33, the plate spring 34, and the like provided to the grinder 1 of the first embodiment are also provided to the grinder 1 of the second embodiment; however, the projection portion 33, the plate spring 34, and the like are omitted in FIGS. 6 to 10 for convenience. In FIG. 10, a cross-sectional planar shape of the fitting portion 32 is a circular shape for convenience. Furthermore, in FIG. 10, the packing gland 11 is omitted for convenience.

A cover 44 is attached to the packing gland 11 of the grinder 1 of the second embodiment. An attachment portion 49 on which a wheel guard 30 is mounted is constituted by the packing gland 11 and the cover 44. A ring-shaped housing portion 55 is provided to the boss portion 11a of the packing gland 11, centering the center line D1. The housing portion 55 is a groove having a depth in a direction along the center line D1 relative to the boss portion 11a.

The cover 44 is fixed to the packing gland 11 with a fixing element such as a screw member so as to cover the housing portion 55. In the packing gland 11, the cover 44 is disposed so as to surround the attachment base 41. The cover 44 is a metal material that is pressed into a plate shape, and the cover 44 is provided with an insertion hole 45. The insertion hole 45 is opened, centering the center line D1, and the insertion hole 45 has a bottom surface whose shape is substantially circular. The attachment base 41 is disposed inside the insertion hole 45. Between an inner circumferential edge 44a constituting the insertion hole 45 of the cover 44 and the attachment base 41, a gap is formed entirely in a circumferential direction. The cover 44 is integrally molded with the metal material, and the inner circumferential edge 44a is elastically deformable.

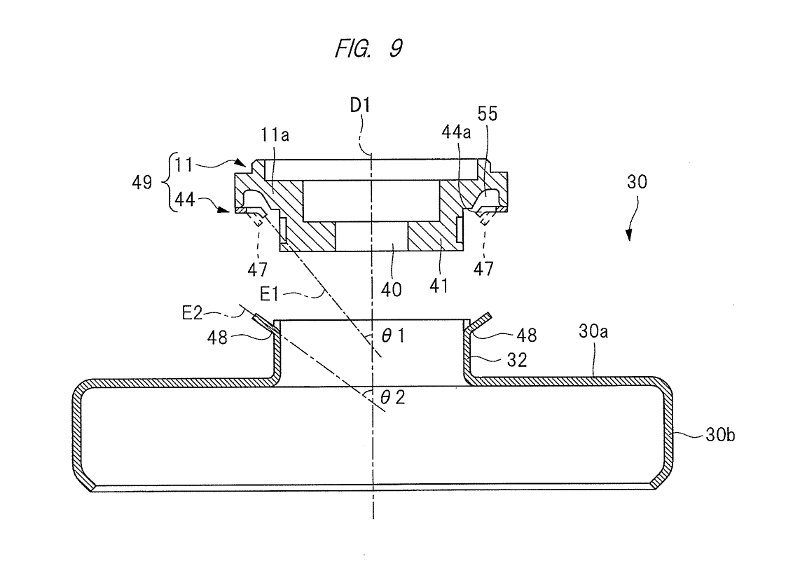

Also, the inner circumferential edge 44a of the cover 44 is provided with two cut-out portions 46. The two cut-out portions 46 are disposed at an interval of 180 degrees in the circumferential direction centering the center line D1. The cut-out portions 46 allow a locking piece 48 to move in or out from the housing portion 55. Moreover, as in FIG. 9, the inner circumferential edge 44a is bent relative to another region of the cover 44, and a center line E1 of the inner circumferential edge 44a crosses the center line D1 at an angle θ1. The angle θ1 is an acute angle of less than 90 degrees. Furthermore, a guide portion 47 is provided to each of both sides of the two cut-out portions 46 of the inner circumferential edge 44a of the cover 44. An angle formed by a center line of the guide portion 47 and the center line D1 on an acute angle side is larger than the angle θ1. The guide portion 47 is continuous to the inner circumferential edge 44a. The guide portion 47 comes in contact with the locking piece 48 entering the housing portion 55 and guides a direction in which the locking piece 48 is elastically deformed.

Meanwhile, the fitting portion 32 is provided with two locking pieces 48. The two locking pieces 48 are disposed at an interval of 180 degrees in a circumferential direction of the fitting portion 32. A width of the locking pieces 48 in the circumferential direction of the fitting portion 32 is smaller than a width of the cut-out portions 46 in a circumferential direction of the insertion hole 45. Furthermore, the two locking pieces 48 protrude in a radial direction relative to an outer peripheral surface of the fitting portion 32. A diameter of a circumscribed circle of the two locking pieces 48 is larger than an inner diameter of the insertion hole 45 and is smaller than a diameter of a circumscribed circle of the two cut-out portions 46.

Next, in the grinder 1 according to the second embodiment, a work of attaching the wheel guard 30 to the packing gland 11 will be described. Note that a relation between the work of attaching the wheel guard 30 to the packing gland 11 in the grinder 1 according to the second embodiment and the work of attaching the wheel guard 30 to the packing gland 11 in the grinder 1 according to the first embodiment will be described below.

As illustrated in FIG. 9, the attachment base 41 of the packing gland 11 and the fitting portion 32 of the wheel guard 30 are concentrically disposed. Here, positions of the two locking pieces 48 are aligned with positions of the two cut-out portions 46 in the circumferential direction of the fitting portion 32.

Then, the wheel guard 30 is put close to the packing gland 11, and as in FIG. 10(A), the two locking pieces 48 are allowed to enter the two cut-out portions 46. Furthermore, the wheel guard 30 is rotated in the circumferential direction of the fitting portion 32 relative to the packing gland 11. Then, each of the two locking pieces 48 comes in contact with the guide portion 47 and is guided so as to elastically deform in a direction away from the horizontal portion 30a. In this way, the two locking pieces 48 enter a space between the inner circumferential edge 44a of the cover 44 and the boss portion 11a of the packing gland 11. Subsequently, as in FIG. 10(B), the two locking pieces 48 stop the wheel guard 30 by friction force at a contact part with the cover 44 at a different position in the circumferential direction of the fitting portion 32 relative to the two cut-out portions 46.

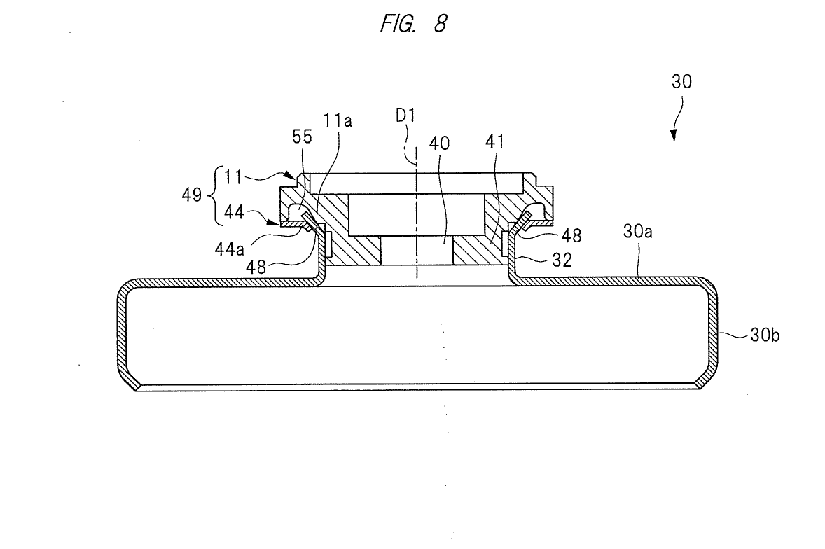

When the wheel guard 30 is stopped, as in FIG. 8, tips of the two locking pieces 48 are housed inside the housing portion 55, and both of the two locking pieces 48 are in a state of being sandwiched between the inner circumferential edge 44a of the cover 44 and the boss portion 11a of the packing gland 11. That is, it is possible to prevent the wheel guard 30 from moving in the direction along the center line D1 in a direction away from the packing gland 11 with engagement force between the two locking pieces 48 and the inner circumferential edge 44a of the cover 44. That is, it is possible to prevent the wheel guard 30 from unintentionally being detached from the packing gland 11, and the wheel guard 30 is positioned in an axial direction. Also, the locking piece 48 of the wheel guard 30 is always engaged with the inner circumferential edge 44a of the cover 44, and energizing force toward a packing gland 11 side in the direction along the center line D1 is always applied to the wheel guard 30.

Thus, it is possible to restrain rattling of the wheel guard 30 in the axial direction. Moreover, since the cover 44 is a single member having two functions, being a member for retaining the wheel guard 30 in the axial direction as well as a member for generating energizing force toward the packing gland 11 side in the wheel guard 30, it is possible to restrain a length in the axial direction along the center line D1.

In contrast, in a case where the wheel guard 30 is detached from the packing gland 11, the wheel guard 30 is rotated in the circumferential direction of the fitting portion 32 relative to the packing gland 11. Then, at the point when the two locking pieces 48 align with the positions of the two cut-out portions 46 in the circumferential direction of the fitting portion 32, the wheel guard 30 is stopped, and the wheel guard 30 is moved in the direction along the center line D1 in the direction away from the packing gland 11.

Here, a relation between the work of attaching the wheel guard 30 to the packing gland 11 in the grinder 1 according to the second embodiment and the work of attaching the wheel guard 30 to the packing gland 11 in the grinder 1 according to the first embodiment is described. First, in the grinder 1 according to the second embodiment, a work of rotating the wheel guard 30 relative to the packing gland 11 is performed in a state where engagement between the projection portion 33 and the recessed portion 42 is released as in FIG. 5(b).

Moreover, in the grinder 1 according to the second embodiment, in a case where the wheel guard 30 is stopped as in FIG. 10(B) after the wheel guard 30 is attached to the packing gland 11, the projection portion 33 is engaged with the recessed portion 42 as in FIG. 5(d), and the wheel guard 30 is positioned in the circumferential direction of the fitting portion 32 relative to the packing gland 11.

Furthermore, in the circumferential direction of the fitting portion 32 of the wheel guard 30, for convenience, a position of the projection portion 33 illustrated in FIGS. 5(a) to 5(d) does not coincide with the positions of the two locking pieces 48 illustrated in FIGS. 10(A) and 10(B). Further, the positions to stop the wheel guard 30 relative to the packing gland 11 also do not coincide with each other between FIGS. 5(d) and 10(B) for convenience. Still further, in the circumferential direction of the fitting portion 32, a correspondence relation between a disposed position of a plurality of projection portions 33 illustrated in FIG. 5 and a disposed position of the two cut out portions 46 of the cover 44 illustrated in FIG. 10 does not coincide for convenience.

In the grinder 1 according to the second embodiment, positions of the two cut-out portions 46 in the circumferential direction relative to the cover 44, positions of the two cut-out portions 46 relative to the circumferential direction of the fitting portion 32, positions of the plurality of recessed portions 42, positions of the two locking pieces 48 in the circumferential direction relative to the fitting portion 32, a position of the projection portion 33 in the circumferential direction relative to the fitting portion 32, and the like are practically designed in such a way that the projection portion 33 provided to the fitting portion 32 can be engaged with the recessed portion 42 in a case where the two locking pieces illustrated in FIG. 10(B) stop the wheel guard 30 at positions different from the positions of the two cut-out portions 46 in the circumferential direction of the fitting portion 32.

Furthermore, in the grinder 1 according to the second embodiment, in a case where an angle on the acute angle side formed by the center line E1 of the inner circumferential edge 44a of the cover 44 and the center line D1 is denoted by θ1 and an angle on the acute angle side formed by a center line E2 of the locking piece 48 and the center line D1 is denoted by θ2 as illustrated in FIG. 9, the angle θ2 may be set to be larger than the angle θ1.

In this way, in a case where the angle θ2 is set to be larger than the angle θ1, when the two locking pieces 48 enter the space between the boss portion 11a of the packing gland 11 and the inner circumferential edge 44a, the two locking pieces 48 are elastically deformed in a direction of decreasing the angle θ2. Then, the inner circumferential edge 44a receives elastic restoration force of the two locking pieces 48, and with reaction force thereof, the inner circumferential edge 44a presses the two locking pieces 48 against the boss portion 11a. Thus, it is possible to restrain the wheel guard 30 from rotating in the circumferential direction relative to the packing gland 11.

Also, as illustrated in FIG. 9, since the center line E2 is not a right angle but an acute angle relative to the center line D1, in a case where the tips of the two locking pieces 48 are housed in the housing portion 55 by the two locking pieces 48 being elastically deformed, the two locking pieces 48 come in contact with the guide portions 47 and are easily elastically deformed. Thus, it is possible to absorb dimensional tolerances for the cover 44, the locking piece 48, the fitting portion 32, and the like as well as to improve workability in attaching the wheel guard 30 to the packing gland 11.

Furthermore, it is not necessary that the grinder 1 according to the second embodiment is provided with the engagement portion 41a, the projection portion 33, the recessed portion 42, the plate spring 34, and the like described in the grinder 1 according to the first embodiment. In this case, as long as the angle θ2 is set to be larger than the angle θ1, the inner circumferential edge 44a presses the two locking pieces 48 against the boss portion 11a, so that rotation of the wheel guard 30 in the circumferential direction relative to the packing gland 11 can be restrained, whereby unintentional moving of the wheel guard 30 in the circumferential direction can be avoided.

(First Modification)

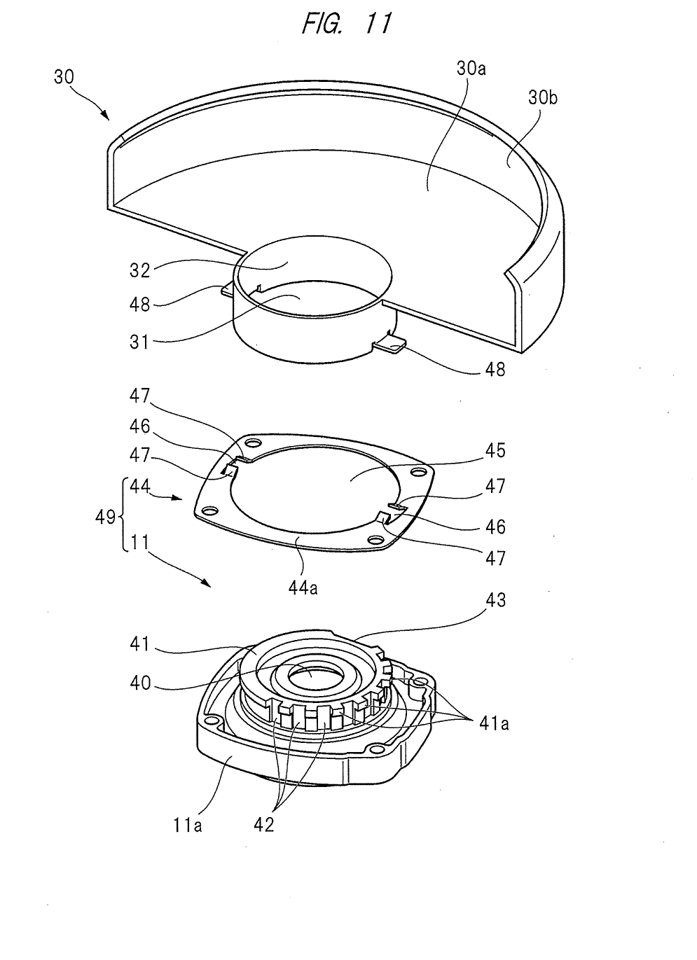

Furthermore, a first modification of the wheel guard 30 and the cover 44 used in the grinder 1 of the second embodiment will be described with reference to FIGS. 11 to 13. The two locking pieces 48 extend in parallel with the horizontal portion 30a. That is, an angle θ3 formed by the center line E1 of the two locking pieces 48 and the center line D1 is 90 degrees. Furthermore, the inner circumferential edge 44a extends at a right angle relative to the center line D1.

Note that the projection portion 33, the plate spring 34, and the like provided to the grinder 1 according to the first embodiment are also provided to the wheel guard 30 and the packing gland 11 of FIGS. 11 to 13; however, the projection portion 33, the plate spring 34, and the like are omitted in FIGS. 11 to 13 for convenience.

The work of attaching the wheel guard 30 illustrated in FIGS. 11 to 13 to the packing gland 11 and a work of detaching the wheel guard 30 from the packing gland 11 are described herein. Note that a work and an action related to the projection portion 33, the recessed portion 42, the plate spring 34, and the like in the wheel guard 30 and the packing gland 11 illustrated in FIG. 11 will be described below.

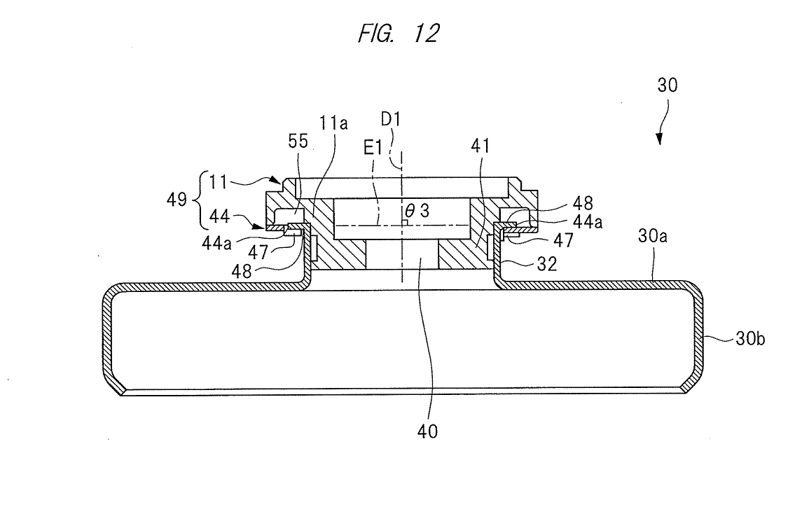

First, in the same manner as in FIG. 10(A), the two locking pieces 48 and the two cut-out portions 46 are disposed at the same positions in the circumferential direction, and the wheel guard 30 is put close to the packing gland 11. A leading end of the fitting portion 32 comes in contact with the boss portion 11a as in FIG. 12. At this point, the two locking pieces 48 are overlapped with the guide portions 47 in the direction along the center line D1.

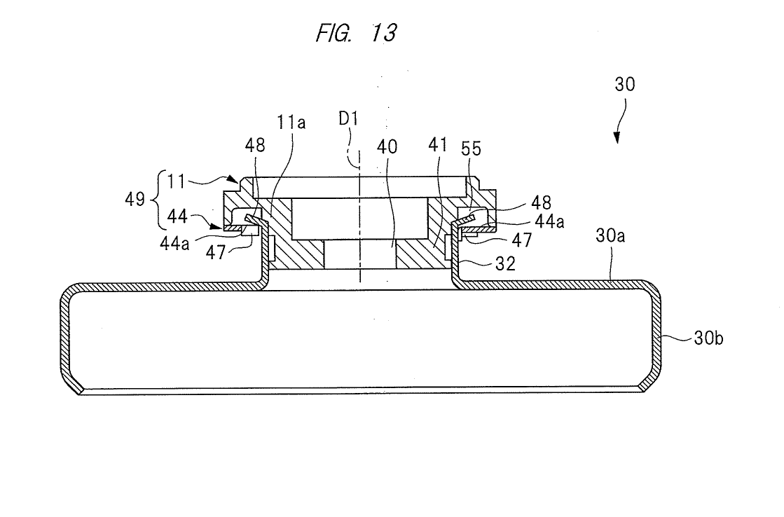

Subsequently, when the wheel guard 30 is rotated relative to the packing gland 11, the two locking pieces 48 come in contact with the cover 44 and are elastically deformed, and the two locking pieces 48 run on the inner circumferential edge 44a as in FIG. 13, so that the tips of the two locking pieces 48 are housed in the housing portion 55. The inner circumferential edge 44a is pressed against the two locking pieces 48, whereby friction force is generated. Thus, in the same manner as in FIG. 10(B), by stopping the wheel guard 30 relative to the packing gland 11, the wheel guard 30 is positioned in the circumferential direction due to the friction force at a contact part between the two locking pieces 48 and the cover 44.

By having such a configuration provided with the guide portion 47, even when it is configured so as to sandwich the locking pieces 48 with strong force by setting a dimension between the inner circumferential edge 44a of the cover 44 and the boss portion 11a of the packing gland 11 to be substantially the same as or smaller than a dimension of the locking pieces 48 in a thickness direction, since the guide portion 47 has a guiding function allowing the locking pieces 48 to enter the space between the inner circumferential edge 44a and the boss portion 11a, it is possible to securely perform positioning of the wheel guard 30 in the axial direction without impairing operability.

Moreover, by rotating the wheel guard 30 in the circumferential direction relative to the packing gland 11, it is possible to change a position of the wheel guard 30 in the circumferential direction relative to the packing gland 11. Furthermore, in a case where the wheel guard 30 is detached from the packing gland 11, the wheel guard 30 is rotated in the circumferential direction, the two locking pieces 48 and the two cut-out portions 46 are disposed at the same positions in the circumferential direction, and the two locking pieces 48 are allowed to pass through the two cut-out portions 46, whereby the wheel guard 30 can be detached from the packing gland 11.

Note that, in the wheel guard 30 and the packing gland 11 illustrated in FIGS. 11 to 13, the work of rotating the wheel guard 30 in the circumferential direction relative to the packing gland is performed after the engagement between the projection portion 33 and the recessed portion 42 has been released. Also, in the wheel guard 30 and the packing gland 11 illustrated in FIG. 11, in a case where the wheel guard 30 is positioned in the circumferential direction relative to the packing gland, the projection portion 33 and the recessed portion 42 are engaged with each other.

Furthermore, it is not necessary that the wheel guard 30 and the packing gland 11 illustrated in FIGS. 11 to 13 are provided with the engagement portion 41a, the projection portion 33, the recessed portion 42, the plate spring 34, and the like described in the grinder 1 according to the first embodiment.

(Second Modification)

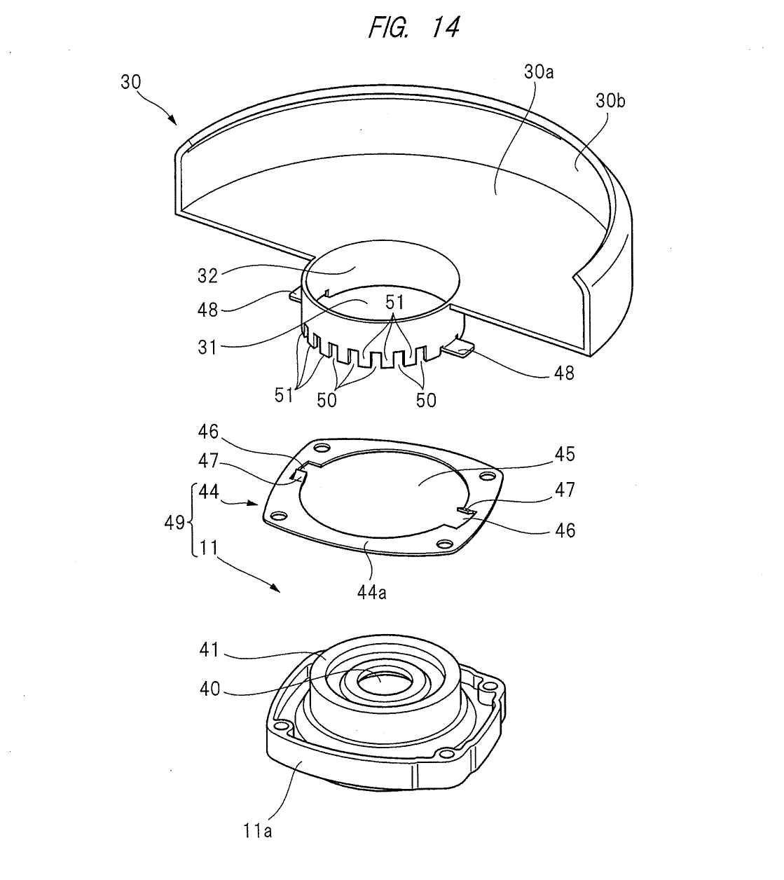

Next, a second modification of the wheel guard and the packing gland used in the grinder 1 of FIG. 6 will be described with reference to FIGS. 14 to 16. The wheel guard 30 and the packing gland 11 are not provided with the projection portion 33, the engagement portion 41a, the recessed portion 42, the plate spring 34, the relief portion 43, and the like described in the grinder 1 according to the first embodiment. Also, the two locking pieces 48 according to the second modification are configured in the same manner as the two locking pieces 48 according to the first modification. Furthermore, the guide portion 47 according to the second modification is provided to each side of the two cut-out portions 46.

Furthermore, a recessed portion 50 and a projection portion 51 are alternately provided to an opening edge of the fitting portion 32 along the circumferential direction. In the circumferential direction of the fitting portion 32, a part where the recessed portion 50 and the projection portion 51 are disposed is different from a part where the two locking pieces 48 are disposed. Also, in the circumferential direction of the fitting portion 32, among two arc-shaped portions formed between the two locking pieces 48, only to one of the arc-shaped portions, a plurality of recessed portions 50 and a plurality of projection portions 51 are disposed.

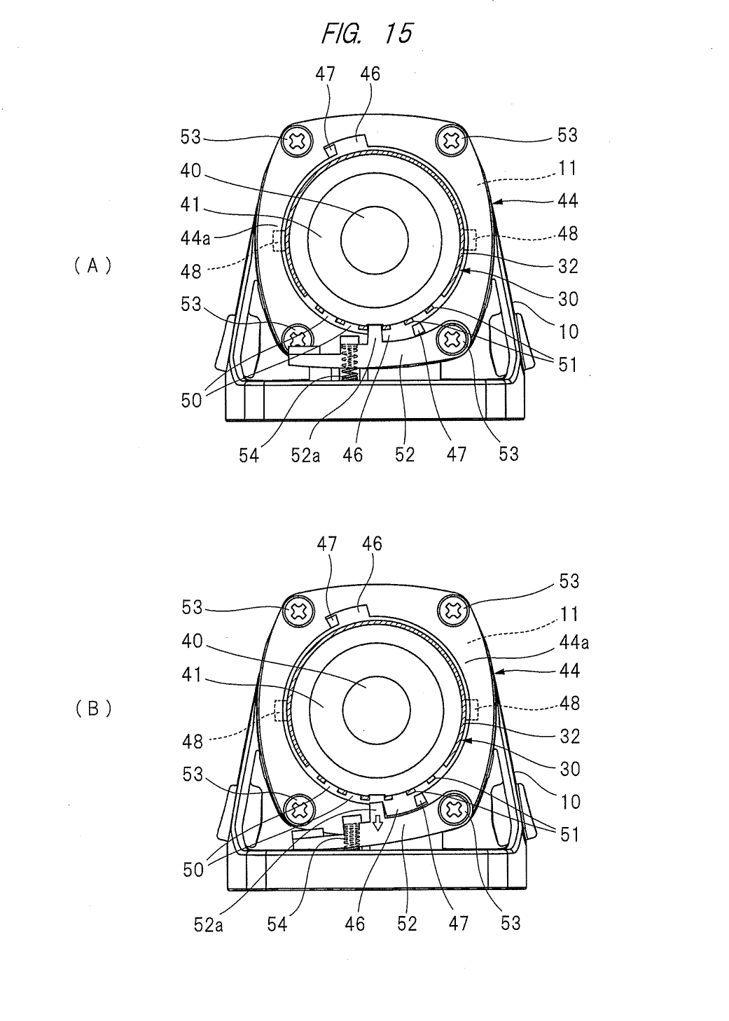

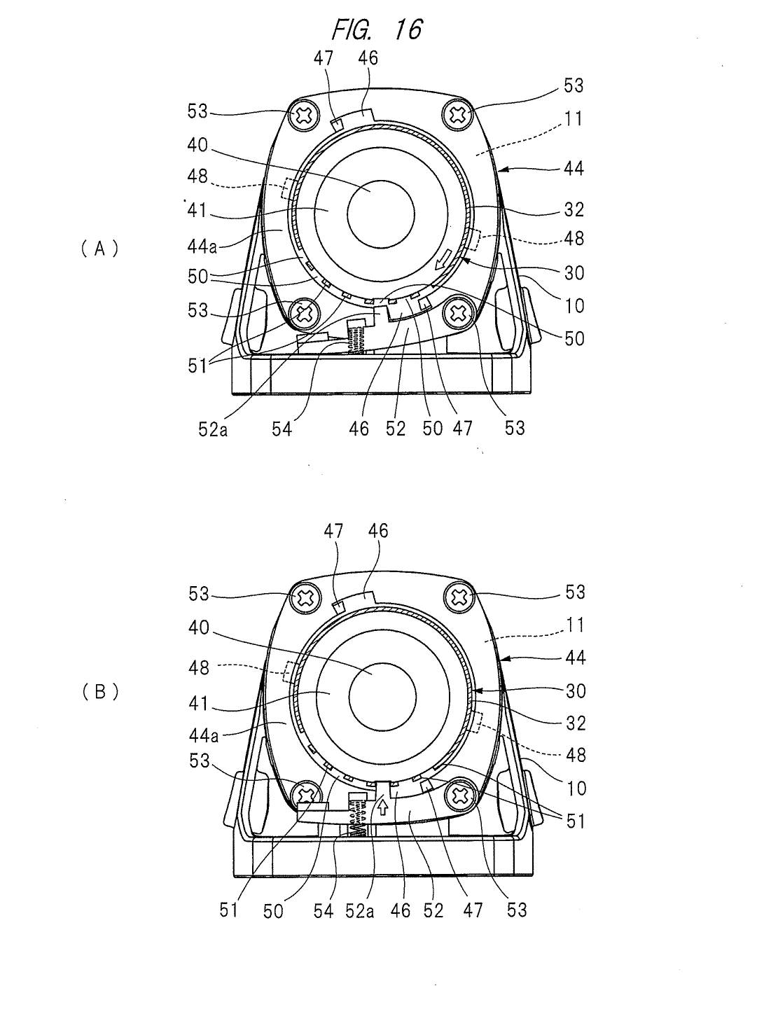

Furthermore, a mechanism for positioning the wheel guard 30 in the circumferential direction relative to the packing gland 11 will be described. A lever 52 is attached to the boss portion 11a of the packing gland 11. The lever 52 is operable with a screw member 53 as a pivot point. The screw member 53 also has a role of fixing the cover 44 to the packing gland 11. The lever 52 is an element to be operated by an operator, and the lever 52 is provided with a projection portion 52a. Also, the lever 52 is also provided with a compression spring 54 as an energization member for energizing the lever 52 in a clockwise direction in FIGS. 15 and 16. The lever 52 is pressed toward the fitting portion 32 by force of the compression spring 54. Note that the lever 52 and the compression spring 54 are omitted in FIG. 14 for convenience.

The work of attaching or detaching the wheel guard 30 to or from the packing gland 11 illustrated in FIGS. 14 to 16 is the same as the work of attaching or detaching the wheel guard 30 to or from the packing gland 11 illustrated in FIGS. 11 to 13.

Next, the work of rotating the wheel guard 30 in the circumferential direction relative to the packing gland 11 will be described. In the wheel guard 30 and the packing gland 11 illustrated in FIG. 15(A), the two locking pieces 48 are at positions different from positions of the two cut-out portions 46 in the circumferential direction of the fitting portion 32. Thus, the wheel guard 30 is not detached from the packing gland 11. Also, the projection portion 52a of the lever 52 is positioned in the recessed portion 50 of the fitting portion 32, and the projection portion 52a is engaged with the fitting portion 32. That is, the wheel guard 30 is positioned and fixed in the circumferential direction by engagement force between the projection portion 52a and the projection portions 51.

In a case where the wheel guard 30 is rotated in the circumferential direction relative to the packing gland 11, the operator applies operation force to the lever 52 and operates the lever 52 in the counterclockwise direction against the force of the compression spring 54 as in FIG. 15(B). Then, the projection portion 52a of the lever 52 is withdrawn from the recessed portion 50, and engagement between the projection portion 52a and the projection portions 51 is released.

Then, the operator rotates the wheel guard 30 in the clockwise direction as in FIG. 16(A). Subsequently, by releasing the operation force applied to the lever 52, the lever 52 operates in the clockwise direction due to the force of the compression spring 54, and the projection portion 52a of the lever 52 enters the recessed portion 50 as in FIG. 16(B). Here, the recessed portion 50 which the projection portion 52a enters is at a different position in the circumferential direction from the position of the recessed portion 50 which the projection portion 52a has entered in FIG. 15(A). In this manner, it is possible to change a position in the circumferential direction of the wheel guard 30 relative to the packing gland 11.

The present invention is not to be limited to the second embodiment and may be modified in various ways within a scope not deviating from the gist thereof. For example, three or more cut-out portions 46 and three or more locking pieces 48 may be provided. The number of the recessed portions 50 and the projection portions 51 provided to the fitting portion 32 may be arbitrarily set.

Further, in the second embodiment, an example has been described in which the friction force is generated by the two locking pieces 48 being elastically deformed and the inner circumferential edge 44a of the cover 44 being pressed against the two locking pieces 48; however, such a configuration that the friction force is generated by the inner circumferential edge 44a of the cover 44 being elastically deformed and the inner circumferential edge 44a being pressed against the two locking pieces 48 is applicable. In the second embodiment of the present invention, at least a part of the two locking pieces is housed in the housing portion. Furthermore, in the second modification, such a configuration that the lever 52 is energized in the clockwise direction in FIGS. 15(A) to 16(B) by using a tension spring in place of the compression spring 54 is also applicable. Still further, an electric tool according to the present invention includes a structure in which an electric motor is driven by electric power of a commercial power supply and a structure in which the electric motor is driven by electric power of a battery pack mounted on a main body.

A rotating tool attached to the electric tool according to the present invention includes a grindstone wheel, a non-woven fabric wheel, a cotton buff, a sponge pat, a flap wheel, a rotary blade, and the like. Moreover, a process performed with the rotating tool attached to the electric tool according to the present invention includes grinding, polishing, cutting, scraping, and the like. Furthermore, in addition to a grinder, the electric tool according to the present invention also includes a work machine such as a so-called sander, a cutter, and the like.

In a correspondence relation between the configuration of the present invention and the configuration described in each of the embodiments, the grindstone wheel 2 is equivalent to the rotating tool according to the present invention, the spindle 20 is equivalent to the spindle according to the present invention, the wheel guard 30 is equivalent to the wheel guard according to the present invention, the grinder 1 is equivalent to the electric tool according to the present invention, and the main body 5 is equivalent to the main body 5 according to the present invention. Moreover, the housing portion 55 is equivalent to the housing portion according to the present invention, the attachment base 41 and the attachment portion 49 are equivalent to the attachment portions according to the present invention, and the fitting portion 32 is equivalent to the fitting portion according to the present invention. Furthermore, the two protrusion portions 35, the plate spring 34, the projection portion 33, and the two locking pieces 48 are equivalent to the plurality of locking pieces according to the present invention, and the engagement portion 41a and the boss portion 11a are equivalent to a support portion according to the present invention.

In addition, the two cut-out portions 46 are equivalent to the plurality of cut-out portions according to the present invention, the inner circumferential edge 44a is equivalent to the support portion according to the present invention, the packing gland 11 is equivalent to the housing according to the present invention, and the cover 44 is equivalent to the cover according to the present invention. Furthermore, the guide portion 47 is equivalent to the guide portion according to the present invention, the recessed portions 42 and 42a are equivalent to the recessed portions according to the present invention, the projection portions 33 and 52a are equivalent to the projection portions according to the present invention, the plate spring 34 is equivalent to the elastic body according to the present invention, the lever 52 is equivalent to the lever according to the present invention, and the compression spring 54 is equivalent to the energization member according to the present invention.

### EXPLANATION OF REFERENCE CHARACTERS

1 . . . grinder, 2 . . . grindstone wheel, 5 . . . main body, 11 . . . packing gland, 20 . . . spindle, 30 . . . wheel guard, 32 . . . fitting portion, 33, 52a . . . projection portion, 34 . . . plate spring, 44 . . . cover, 42, 42a . . . recessed portion, 44a . . . inner circumferential edge, 46 . . . cut-out portion, 47 . . . guide portion, 48 . . . locking piece, 49 . . . attachment portion, 52 . . . lever, 54 . . . compression spring, 55 . . . housing portion.

1. An electric tool comprising:
a spindle on which a rotating tool is mounted;
a wheel guard covering the rotating tool mounted on the spindle;
an attachment portion including a housing portion and provided to a main body rotatably holding the spindle so as to surround the spindle;
a fitting portion provided to the wheel guard and being fitted into the attachment portion;
a plurality of locking pieces disposed to the fitting portion at a different position in a circumferential direction of the spindle;
a plurality of cut-out portions disposed to the attachment portion at a different position in the circumferential direction and allowing at least one of the plurality of locking pieces to enter the housing portion; and
a support portion disposed to the attachment portion at a different position from the positions of the plurality of cut-out portions in the circumferential direction and being pressed against the plurality of locking pieces housed in the housing portion.

2. The electric tool according to claim 1,
wherein the attachment portion includes a housing attached to the main body, and a cover attached to the housing,
the support portion and the plurality of cut-out portions are provided to the cover, and
the support portion is elastically deformed and is pressed against the plurality of locking pieces.

3. The electric tool according to claim 1,
wherein the plurality of locking pieces include two locking pieces disposed at an interval of 180 degrees in the circumferential direction, and
the plurality of cut-out portions include two cut-out portions disposed at an interval of 180 degrees in the circumferential direction.

4. The electric tool according to claim 2,
wherein the cover guides the plurality of locking pieces entering the plurality of cut-out portions, respectively, toward the housing portion, and
the cover is provided with a guide portion disposed between the cut-out portions and the support portion in the circumferential direction.

5. The electric tool according to claim 1, further comprising:
a recessed portion provided to any one of the attachment portion and the fitting portion; and
a projection portion provided to the other of the attachment portion and the fitting portion and positioning the wheel guard in the circumferential direction by engaging with the recessed portion.

6. The electric tool according to claim 5,
wherein an elastic body energizing any one of the projection portion and the recessed portion toward the other of the projection portion and the recessed portion is disposed between the fitting portion and the attachment portion in a radial direction of the spindle.

7. The electric tool according to claim 5,
wherein the recessed portion is provided to the attachment portion, and
the projection portion is provided to the fitting portion.

8. The electric tool according to claim 5,
wherein the fitting portion has a cylindrical shape and has the recessed portion being disposed in plurality along the circumferential direction of the fitting portion, and
a lever being operable along the radial direction of the spindle and having the projection portion is provided to the attachment portion outside of the fitting portion.

9. The electric tool according to claim 8, further comprising:
an energization member energizing the lever toward the fitting portion and holding a state in which the projection portion is fitted into the recessed portion is provided.
